(19) United States
(12) Patent Application Publication
(10) Pub. No.: US 2012/0079122 A1
(43) Pub. Date: Mar. 29, 2012

(54) DYNAMIC SWITCHING OF A NETWORK CONNECTION BASED ON SECURITY RESTRICTIONS

(75) Inventors: Michael Stephen Brown, Kitchener (CA); Herbert Anthony Little, Waterloo (CA); Christopher Lyle Bender, Waterloo (CA)

(73) Assignee: RESEARCH IN MOTION LIMITED, Waterloo (CA)

(21) Appl. No.: 13/204,227

(22) Filed: Aug. 5, 2011

Related U.S. Application Data
(60) Provisional application No. 61/386,228, filed on Sep. 24, 2010.

(51) Int. Cl. G06F 15/16

(52) U.S. Cl. 709/227

(57) ABSTRACT

Systems and methods for providing access to an enterprise network from a remote computer are described. In one example, a system includes a mobile device configurable for connection to the remote computer, the mobile device adapted to establish secure communication to the enterprise network and a connection server application located on the mobile device for receiving a request from the remote computer specifying a location and a connection path and selectively providing to the remote computer access to the enterprise network via the mobile device based on the request. Other implementations are possible.

### CROSS REFERENCE TO RELATED APPLICATION

This application claims the benefit of U.S. Provisional Application No. 61/386,228, filed Sep. 24, 2010, the entire content of which is hereby expressly incorporated by reference.

### FIELD OF THE DISCLOSURE

The present disclosure relates generally to the field of computer networks and particularly to the accessing a restricted networks such as an enterprise network from a remote computer and to dynamically configuring applications based on different access restrictions.

### BACKGROUND

Many companies allow users to access internal corporate networks and resources from an external location using a device, such as a tablet or a personal computer (PC), that may be the user's personal device over which the company has little or no control. Typically these devices include applications that are used to access information on the corporate network. More frequently corporate applications are delivered as Web content that can be rendered by a browser running on these devices.

Generally, the device may not be allowed direct access to a user's corporate network using the device's Internet connection. A typical solution to this problem is to establish a Virtual Private Network (VPN) connection from the device to the user's corporate network. In a typical scenario, a user working on a remote computer connects to the Internet and initiates a client side VPN program. The VPN program uses an acceptable networking protocol to access a company's VPN gateway computer. The gateway computer, e.g., a VPN server, authenticates the user and establishes a remote networking session for the remote user.

However, a VPN infrastructure can be cumbersome to deploy and use, requiring servers in the corporate network and security mechanisms like hardware tokens or certificates to be distributed and maintained. Also, during the time that a VPN connection is active, many operating systems or corporate security policies may require that all traffic into or out of the device is routed over the VPN via the user's corporate network. There are some drawbacks to this setup. Since the VPN infrastructure is generally inflexible, all Internet traffic for example will be routed through the corporation. This is likely to be noticeably slower for the end user. Company resources will also be consumed when the employee or even a family member is browsing the Internet. Additionally, the company may block access to certain websites from the corporate network, so the user's browsing experience may be restricted.

Thus the VPN model may in some instances be too rigid for accessing restricted networks from remote locations.

### BRIEF DESCRIPTION OF THE DRAWINGS

The present system and method will be better understood with reference to the drawings in which:

FIG. 1 is a simplified block diagram of a system for remote access to a corporate network;

FIG. 2 is a block diagram of a system for remote access to a corporate network according to one embodiment of the present matter;

FIG. 3 is a representation of a graphical user interface in accordance with one embodiment of the present matter;

FIG. 4 is a representation of a graphical user interface in accordance with another embodiment of the present matter; and

FIG. 5 is a block diagram of an exemplary mobile device that can be used in accordance with the present matter.

### DETAILED DESCRIPTION OF THE DRAWINGS

In accordance with the present matter there is provided a method for accessing an enterprise network from a first device comprising the steps of sending a request to a second device from a connection client application located on the first device, the second device having a secure connection with the enterprise network; and receiving from the second device responses to the request wherein the request is a request for processing by a connection server application located on the second device for selectively accessing the enterprise network.

In accordance with a further aspect applications located on said remote computer may be configured for generating the requests.

In accordance with a still further aspect the generated request is for access to restricted resources on the enterprise network.

In accordance with a still further aspect the generated request is for public resources.

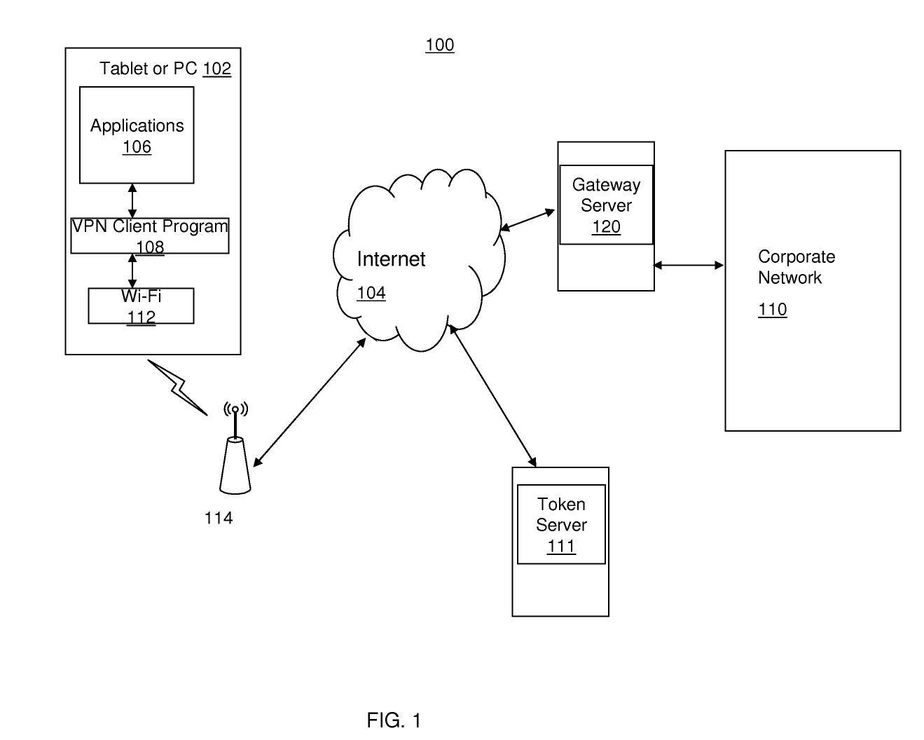

Referring to FIG. 1 there is shown aspects of a typical system 100 for accessing an enterprise or corporate network as an example of a restricted access network. The system includes at least one remote computer 102 connected to an external network 104, such as, for example, the Internet. The remote computer 102 may connect to any other computer or network connected to the Internet. The remote computer may access the Internet using its Wi-Fi module 112 to connect through a public or private access point 114. Alternatively, the remote computer 102 may access the Internet using a cellular radio. The remote computer 102 has an operating system as well as a plurality of applications 106. The operating system may include storage that contains configuration information of the operating system and the applications 106. In the present disclosure, these applications 106 may be document processing applications, Internet browsers, audio or video applications, e-mail programs, anti-virus programs, games, or other applications a user may elect to install.

A enterprise or business system includes a corporate network 110 connected, or bridged, to the external network 104 through a firewall or gateway server 120 which serves to restrict access to the corporate internal network from unauthorized remote computers on the external network 104. Access to the internal network may be allowed when the remote computer 102 presents a token containing the appropriate authorizations to a token server 111. As will be recognized by those skilled in the art, many servers may be connected to the corporate network 110. Further, any suitable network connection may be implemented in place of the Internet, although connection using HTTP or HTTPS is typical. Additionally, other corporate resources may be accessible through servers although these resources are not illustrated in FIG. 1. Examples of corporate resources may be, but are not limited to, printers, e-mail servers, applications servers, proxy servers, and scanners.

Each remote computer 102 comprises a VPN client application 108. The VPN client application 108 facilitates secure communication between the remote computer 102 and servers (not shown) on the corporate network 110, and once a VPN connection is established, provides a user with the ability to access corporate network resources. The VPN client application 108 is adapted to perform security checks required by the corporate servers.

As indicated above, one typical disadvantage is that a VPN solution has limited adaptability to changing user and corporate needs so that, for example, if a remote computer establishes a VPN connection with the corporate network 110 then all browsing from the remote computer is to be through the VPN connection. Furthermore it is expensive from both a hardware and maintenance perspective for a corporation to support each VPN connection.

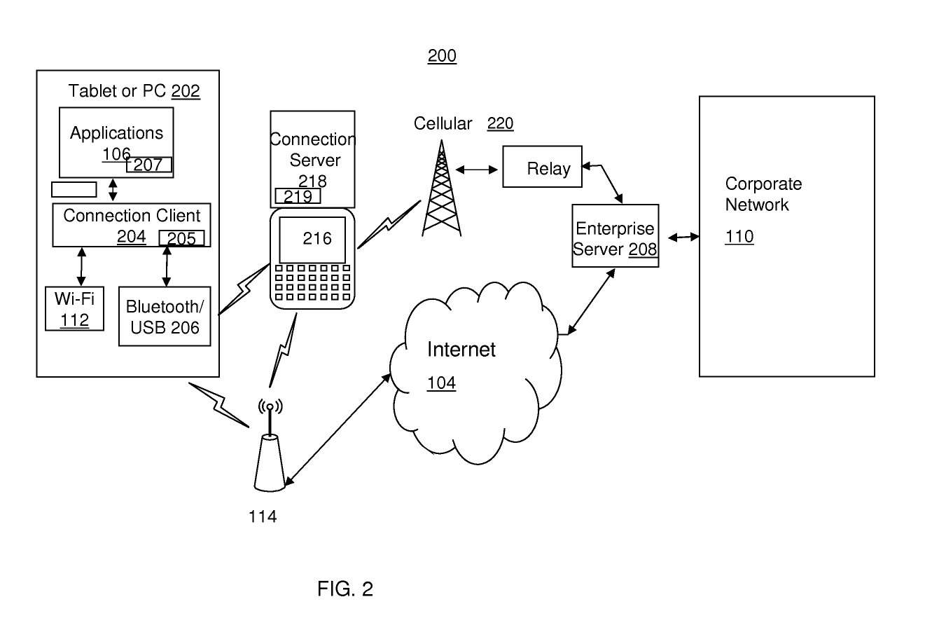

Referring now to FIG. 2 there is shown a system 200 for remote access to an enterprise network or business system 110 according one embodiment of the present disclosure. The system 200 includes a first device such as a remote computer 202 desiring access to the enterprise system 110, and at least one second device such as a mobile device 216 for communication with the enterprise 110 via a secure connection, for example, via a cellular network 220 located outside the enterprise. For the purpose of this disclosure a mobile device is exemplified as a type of device that has an existing authorised access to the enterprise network. The remote computer 202 such as tablet or pc includes a connection client module 204 to establish communication with a connection server module 218 located on the mobile communications device 216 that already has access to the user's corporate network 110. Connectivity between the mobile device 216 and the computer 202 may be via Bluetooth, USB or similar trusted wired or wireless connection 206. Alternatively, connectivity between the mobile device 216 and the computer 202 may be facilitated via a wide-area network to which both have access, such as a WiFi network. The computer 202 may also include a Wi-Fi module 112 to connect through a public or private access point 114 to the Internet 104. Connection to the Internet may also be via a wired network connection (not shown). The computer 202 includes applications 106 as described in reference to FIG. 1.

In one embodiment the communication protocol between the computer 202 and the connected mobile device is via HTTP. Accordingly, the connection client module 204 includes a proxy application 205 and the connection server module 218 includes a protocol translation application 219. Generally, the protocol translation application 219 translates messages between the proxy application 205 and the connection established to the enterprise network by the mobile device 216. The system 200 thereby facilitates the establishment of a “virtual private network” like connection between the enterprise network 212 and the remote computer 202.

The connection client module 204 and the connection server module 218 may also be configured in various ways to facilitate a particular connection type scenarios corresponding to various corporate security requirements.

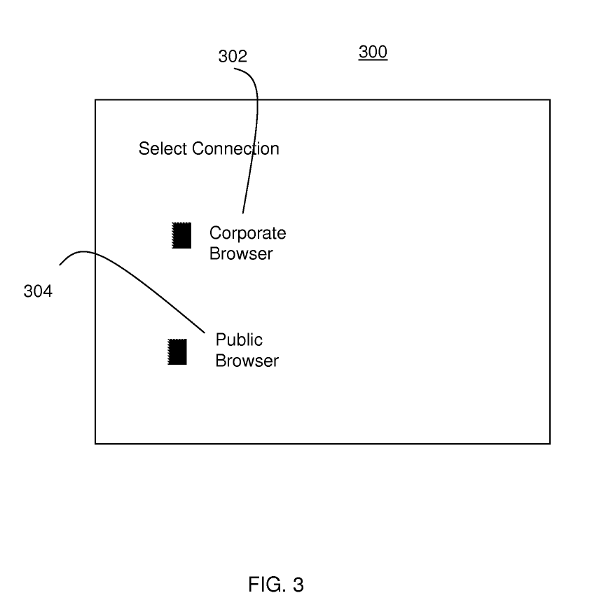

This may be better illustrated by considering a specific example of an application 106 such as a browser application 207 on the computer 202. In this case the proxy application 205 could be a HTTP proxy. Upon receiving an HTTP request from an application running on the computer 202, the proxy application 205 could forward the request to the proxy translation application 219 using an appropriate protocol for the link between computer 202 and mobile device 216. The protocol translation application 219 on the mobile device 216 would then process the HTTP request. The browser 207 may be either manually or automatically configured for connection through the proxy application 205. For example, the Browser window (not shown) on the computer 202 may have a connection selection button that initiates a user interface window 300 shown in FIG. 3 that displays icons corresponding to connectivity options for the user. For example the window 300 includes option buttons labelled “corporate browser” 302 and “public browser” 304 that may be presented to a user such that when the user activates the option labelled “corporate browser”, that instance of the browser process may be configured dynamically to use this HTTP proxy. However, when the user activates the option labelled “public browser” 304, that instance of the browser process may be configured dynamically not to use the HTTP proxy 205 to the mobile device 216, but to simply use the remote computer's own connection 214 to the Internet 104.

Note that in general, there may be multiple instances of the browser process running, and the present embodiment may allow each to be configured independently, i.e. there may be some corporate browser instances and some public browser instances running on the same device at the same time. This allows users to access different resources via different routing paths, e.g. they can access any corporate websites using the corporate browser, and they can access other websites using the public browser, including websites that may have been “blocked” by the corporation.

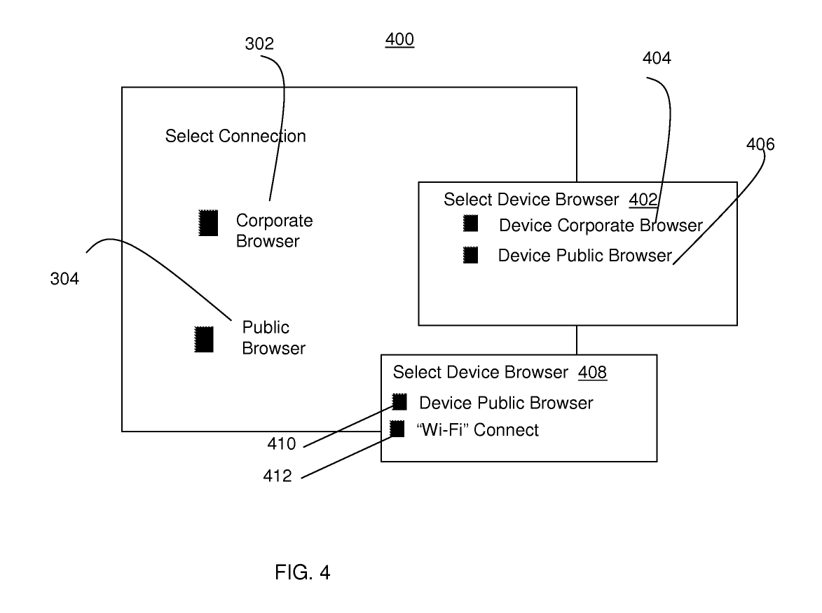

In a still further embodiment the mobile device 216 itself may support browsing via multiple different browsing services. For example, in addition to the corporate browser service described above, the mobile device 216 may have a public browser service as well. Again using the browser example, the browser window (not shown) on the computer 202 may again have a connection selection button that initiates in a graphical user interface, display of a window 400 shown in FIG. 4 that displays icons corresponding to connectivity options for the user. In this case the window 400 also includes option buttons labelled “corporate browser” 302 and “public browser” 304, however if the user activates the option labelled “corporate browser” another window 402 is displayed for selection of the mobile device connection as either the “device corporate browser” 404 or the “device public browser” 406. If the user activates the option labelled “public browser” 304 then a window 408 with an option for selecting the mobile device public browsing 410 is displayed. Thus with this option 410 the remote computer 202 provides another public browsing option that is still proxied via the mobile device 216. In addition an option for direct browsing 412 using the computer's Wi-Fi connection 112 may be presented.

In a still further embodiment (not shown) the connection type may be chosen by displaying multiple browser icon (i.e. application shortcuts) options on the user interface of computer 202. For example the user interface may display one icon labelled “public browser” for public browsing and another icon labelled “corporate browser” for public browsing. The user simply launches the appropriate application by clicking on the icon for example. Thus with this embodiment there is no dialog implemented as described with the previous embodiments of FIG. 3 and FIG. 4 above. Thus the public and private browser applications may be preconfigured to use the appropriate connection type. These may be separate applications or may be instances of the same application with different configurations.

Alternatively users may be allowed to preconfigure their applications with a connection type which is saved and associated with the application.

As mentioned earlier, the computer 202 and the connected mobile device 216 communicate the desired connection using the protocol translation application 219 on the mobile device 216 and the proxy application 205 on the computer 202. This may be implemented in one of many techniques on the computer 202. For example the proxy application 205 may transmit an URL parameter to the mobile device to inform the protocol translation module 218 of a desired type of connection.

For example, if the connected computer 202 would like to browse via the mobile devices 216 corporate browsing service on http://internal/. The user would have selected the option “corporate browser” 302 and the option “device corporate browser” 404 in which case the computer 202 may, for example, issue a request such as http://internal/?type=work. In which case the protocol translation application 219 would recognise this and use the mobile device's 216 internal corporate browser services.

In another embodiment, the request from the computer 202 may use an HTTP header instead. For example, when the connected remote computer 202 would like to browse via the mobile devices 216 corporate browsing service, it may add an HTTP header named “Connection-Type:” with a value of “work”. Again the protocol translation application 219 would recognise this and use the mobile device's 216 internal corporate browser services.

In another embodiment, the proxy application 205 may expose multiple network interfaces or ports, and each exposed port may correspond to a different type of browser service. The desired port may be communicated to the mobile device 219 as a parameter of the protocol between proxy application 205 and protocol translation application 219, that is, outside of the HTTP request itself. In this embodiment, an application on the computer can request a particular browsing service by simply directing the HTTP request to a particular port exposed by the proxy application 205.

It is to be noted that the protocol translation application 219 not only handles requests but handles responses back to the connected computer 202. Likewise the proxy application 205 also handles responses from the connected mobile device 216.

As may be seen that the present system 200 leverages mobile devices that support multiple different browsing services to provide if so desired multiple concurrent active browser instances. Thus the remote computer 202 dynamically and actively makes a decision between its own connection and the mobile devices connection (or between the multiple connections on the mobile device). It is to be noted the present system is fundamentally different from tethering which simply allows a remote computer to access the Internet via the wireless carrier network. In order to browse to a user's corporate network, a separate VPN as described in FIG. 1 would still be required on top of this tethered connection.

Furthermore the present application allows the mobile device to provision a suitable configuration policy based on corporate requirements to the remote computer. This configuration policy may be enforced in the proxy module.

In a still further embodiment, the remote computer 202 can also enforce security restrictions on the resources that are accessed from the various different browser configurations. For example, resources downloaded from the corporate browser or other “corporate” application may be treated as “corporate” resources and stored in a secure location 236 on the computer 202 such that non-corporate applications running on the computer may not be granted access to those resources.

While the above has been described with reference to a Browser applications it is understood that the systems and methods described herein apply to other applications such as file browsers, email applications, word-processing, time management, spreadsheets to name a few.

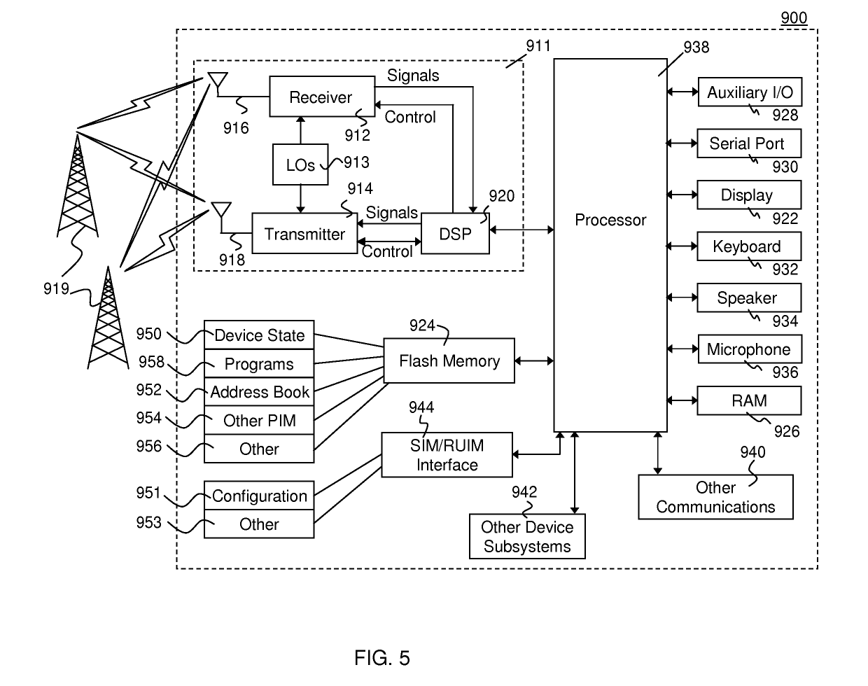

One skilled in the art will appreciate that many mobile devices could be used to implement the above. An exemplary mobile device is illustrated below with reference to FIG. 5. The mobile device of FIG. 5 is however not meant to be limiting and other mobile devices could also be used.

Mobile device 900 is typically a two-way wireless communication device having voice and data communication capabilities. Mobile device 900 generally has the capability to communicate, with other devices or computer systems. Depending on the exact functionality provided, the mobile device may be referred to as a data messaging device, a two-way pager, a wireless e-mail device, a cellular telephone with data messaging capabilities, a wireless Internet appliance, a wireless device, a user equipment, or a data communication device, as examples.

Where mobile device 900 is enabled for two-way communication, it will incorporate a communication subsystem 911, including both a receiver 912 and a transmitter 914, as well as associated components such as one or more antenna elements 916 and 918, local oscillators (LOs) 913, and a processing module such as a digital signal processor (DSP) 920. As will be apparent to those skilled in the field of communications, the particular design of the communication subsystem 911 will be dependent upon the communication network in which the device is intended to operate.

Network access requirements will also vary depending upon the type of network 919. In some networks, network access is associated with a subscriber or user of mobile device 900. A mobile device may require a removable user identity module (RUIM) or a subscriber identity module (SIM) card in order to operate on the network. The SIM/RUIM interface 944 may be similar to a card-slot into which a SIM/RUIM card can be inserted and ejected like a diskette or PCMCIA card. The SIM/RUIM card can have memory and hold many key configuration 951, and other information 953 such as identification, and subscriber related information.

When required network registration or activation procedures have been completed, mobile device 900 may send and receive communication signals over the network 919. As illustrated in FIG. 5, network 919 can consist of multiple base stations communicating with the mobile device. For example, in a hybrid CDMA lx EVDO system, a CDMA base station and an EVDO base station communicate with the mobile station and the mobile device is connected to both simultaneously. In other systems such as Long Term Evolution (LTE) or Long Term Evolution Advanced (LTE-A), multiple base stations may be connected to for increased data throughput. Other systems such as GSM, GPRS, UMTS, HSDPA, among others are possible and the present disclosure is not limited to any particular cellular technology.

Signals received by antenna 916 through communication network 919 are input to receiver 912, which may perform such common receiver functions as signal amplification, frequency down conversion, filtering, channel selection and the like, and in the example system shown in FIG. 5, analog to digital (A/D) conversion. A/D conversion of a received signal allows more complex communication functions such as demodulation and decoding to be performed in the DSP 920. In a similar manner, signals to be transmitted are processed, including modulation and encoding for example, by DSP 920 and input to transmitter 914 for digital to analog conversion, frequency up conversion, filtering, amplification, and transmission over the communication network 919 via antenna 918. DSP 920 not only processes communication signals, but also provides for receiver and transmitter control. For example, the gains applied to communication signals in receiver 912 and transmitter 914 may be adaptively controlled through automatic gain control algorithms implemented in DSP 920.

Mobile device 900 generally includes a processor 938 which controls the overall operation of the device. Communication functions, including data and voice communications, are performed through communication subsystem 911. Processor 938 also interacts with further device subsystems such as the display 922, flash memory 924, random access memory (RAM) 926, auxiliary input/output (I/O) subsystems 928, serial port 930, one or more keyboards or keypads 932, speaker 934, microphone 936, other communication subsystem 940 such as a short-range communications subsystem and any other device subsystems generally designated as 942. Serial port 930 could include a USB port or other port known to those in the art.

Some of the subsystems shown in FIG. 5 perform communication-related functions, whereas other subsystems may provide “resident” or on-device functions. Notably, some subsystems, such as keyboard 932 and display 922, for example, may be used for both communication-related functions, such as entering a text message for transmission over a communication network, and device-resident functions such as a calculator or task list, among other applications.

Operating system software used by the processor 938 may be stored in a persistent store such as flash memory 924, which may instead be a read-only memory (ROM) or similar storage element (not shown). Those skilled in the art will appreciate that the operating system, specific device applications, or parts thereof, may be temporarily loaded into a volatile memory such as RAM 926. Received communication signals may also be stored in RAM 926.

As shown, flash memory 924 can be segregated into different areas for both computer programs 958 and program data storage 950, 952, 954, and 956. These different storage types indicate that each program can allocate a portion of flash memory 924 for their own data storage requirements. This may further provide security if some applications are locked while others is not.

Processor 938, in addition to its operating system functions, may enable execution of software applications on the mobile device. A predetermined set of applications that control basic operations, including at least data and voice communication applications for example, will normally be installed on mobile device 900 during manufacturing. Other applications could be installed subsequently or dynamically.

Applications and software, such as those for implementation of the present system and methods may be stored on any computer readable storage medium. The computer readable storage medium may be a tangible or intransitory/hon-transitory medium such as optical (e.g., CD, DVD, etc.), magnetic (e.g., tape) or other memory known in the art.

One software application may be a personal information manager (PIM) application having the ability to organize and manage data items relating to the user of the mobile device such as, but not limited to, e-mail, calendar events, voice mails, appointments, and task items. Naturally, one or more memory stores would be available on the mobile device to facilitate storage of PIM data items. Such PIM application may have the ability to send and receive data items, via the wireless network 919. In one embodiment, the PIM data items are seamlessly integrated, synchronized, and updated, via the wireless network 919, with the mobile device user's corresponding data items stored or associated with a host computer system. Further applications may also be loaded onto the mobile device 900 through the network 919, an auxiliary I/O subsystem 928, serial port 930, short-range communications subsystem 940 or any other suitable subsystem 942, and 922, or alternatively to an auxiliary I/O de mobile device 900 may also compose xample, using the keyboard 932, which or telephone-type keypad, among others ssibly an auxiliary I/O device 928. Such c ver a communication network through communications, overall operation of m eived signals would typically be output to would be generated by a microphone 93 s, such as a voice message recording s obile device 900. Although voice or au d primarily through the speaker 934, disp [symbol] other than through a wireless communication network. The alternate download path may for example be used to load an encryption key onto the device through a direct and thus reliable and trusted connection to thereby enable secure device communication. As will be appreciated by those skilled in the art, serial port 930 can further be used to connect the mobile device to a computer to act as a modem.

Other communications subsystems 940, such as a short-range communications subsystem, is a further optional component which may provide for communication between mobile device 900 and different systems or devices, which need not necessarily be similar devices. For example, the subsystem 940 may include an infrared device and associated circuits and components or a Bluetooth™ communication module to provide for communication with similarly enabled systems and devices

The embodiments described herein are examples of structures, systems, or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems, or methods that do not differ from the techniques of this application as described herein, and further includes other structures, systems, or methods with insubstantial differences from the techniques of this application as described herein.

1. A system for providing access to an enterprise network from a remote computer, the system comprising:
a mobile device configurable for connection to the remote computer, the mobile device adapted to establish secure communication to the enterprise network; and
a connection server application located on the mobile device for receiving a request from the remote computer specifying a location and a connection path and selectively providing to the remote computer access to the enterprise network via the mobile device based on the request.

2. The system of claim 1, wherein the connection path indicates a connection associated with secure communication to the enterprise server.

3. The system of claim 1, wherein the connection path indicates a connection using a public network.

4. The system of claim 1, wherein the connection server application performs a protocol translation responsive to receiving the request.

5. The system of claim 1, wherein the connection path is specified by a hypertext transfer protocol communication.

6. The system of claim 5, wherein the hypertext transfer protocol communication is received from a proxy operating on the remote computer.

7. The system of claim 5, wherein the connection path is specified by a hypertext transfer protocol header.

8. The system of claim 1, wherein the connection path is specified at the remote computer.

9. The system of claim 8, wherein the connection path is specified by a user at the remote computer.

10. The system of claim 8, wherein the connection path is specified when a connection is requested at the remote computer.

11. The system of claim 8, wherein the connection path is specified through a browser interface.

12. The system of claim 1, wherein the remote computer includes a proxy that selectively makes requests to the mobile device based on the connection path.

13. The system of claim 12, wherein the proxy makes a request to the mobile device when connection to the enterprise network is requested.

14. The system of claim 12, wherein the proxy exposes multiple interfaces corresponding to different browser services.

15. The system of claim 1, wherein the mobile device and the remote computer communicate using a trusted connection.

16. The system of claim 1, wherein the request is received from an application on the remote computer.

17. A method on a remote computer for accessing an enterprise network via a mobile device, the method comprising:
establishing a trusted connection between the remote computer and the mobile device, the mobile device adapted to establish a secure connection to the enterprise network;
sending a request from the remote computer to the mobile device, the request specifying a location and a connection path, wherein the mobile device is adapted to selectively provide access to the enterprise network based on the request; and
accessing the enterprise network via the mobile device if the request indicates a resource associated with the enterprise network.

18. The method of claim 17, wherein the trusted connection comprises a wireless connection.

19. The method of claim 17, wherein the trusted connection comprise a short-range radio frequency connection.

20. The method of claim 17, further comprising receiving a connection selection at the remote computer.

21. The method of claim 20, further comprising presenting a user interface window including a connection selection.

22. A method for providing access to an enterprise network from a remote computer, the method comprising:
establishing a trusted connection to the remote computer;
establishing a secure communication to the enterprise network;
receiving a request from the remote computer specifying a location and a connection path; and
selectively providing to the remote computer access to the enterprise network via the mobile device based on the request.

23. The method of claim 22, wherein the connection path indicates a connection associated with secure communication to the enterprise server.

24. The method of claim 22, wherein the connection path indicates a connection using a public network.

25. The method of claim 22, wherein the connection path is specified by a hypertext transfer protocol header.

26. The method of claim 22, wherein the connection path is specified when the connection to the remote computer is established.
